(19) United States
(12) Patent Application Publication
(10) Pub. No.: US 2008/0239876 A1
(43) Pub. Date: Oct. 2, 2008

(54) High intensity vehicle proximity acoustics

(75) Inventors: Elwood G. Norris, Poway, CA (US); James J. Croft, San Diego, CA (US); Norbert P. Daberko, Encinitas, CA (US); Jeffery A. Belka, Rancho Santa Fe, CA (US)

Correspondence Address: THORPE NORTH & WESTERN, LLP., P.O. Box 1219, SANDY, UT, 84091-1219, US

(73) Assignee: American Technology Corporation, San Diego, CA (US)

(21) Appl. No.: 11/901,971

(22) Filed: Sep. 18, 2007

Related U.S. Application Data
(60) Provisional application No. 60/845,329, filed on Sep. 18, 2006.

(51) Int. Cl. H04B 1/02

(52) U.S. Cl. 367/139

(57) ABSTRACT

An acoustic human and animal behavior modification system that is capable of creating a zone of exclusion immediately adjacent a surface vehicle comprises an array of acoustic transducers disposed on the vehicle in a location not readily seen nor accessible by humans adjacent the vehicle, and is configured to project an acoustic output radially outward in a radial sector at sound pressure levels above the ordinary human pain threshold to motivate animals and humans to move away from a vehicle or change their behavior.

### RELATED APPLICATIONS

Priority is claimed to copending U.S. Provisional Patent Application Ser. No. 60/845,329, filed Sep. 18, 2006, which is hereby incorporated herein by reference in its entirety.

### FIELD OF THE INVENTION

The present invention relates generally to acoustic warning systems, and more particularly, to acoustic warning and protection systems capable of motivating people and/or animals to change their behavior or move back away from the vehicle.

### BACKGROUND OF THE INVENTION AND RELATED ART

It is often desirable to move a vehicle such as a truck, armored car, military vehicle or passenger car through a crowded area when persons or animals in the crowd (or herd) are disinclined to allow this. Unfortunately it is also true that sometimes the security of persons in a vehicle are threatened by persons approaching, blocking, or striking the vehicle. When persons or things in a vehicle are important, valuable, controversial, or perceived as victimizable for some reason, they can be a target of violent action.

Such grave considerations aside, it has been recognized that it often can be desirable to induce people and even animals, to move away from a vehicle in many circumstances. Horns, designed primarily to alert others to the presence of a vehicle, can be loud and annoying. But they can be ineffective in deterring determined persons or unintelligent animals from approaching or blocking a vehicle. Some vehicles are equipped with one or more sirens, which are generally more obnoxious at close range than a simple horn. But again, sirens are designed to alert, and can be ineffective in inducing persons or animals to move. One prior solution with regard to people approaching or crowding a vehicle is to provide arms to persons in or on the vehicle, with which they can threaten persons with grave bodily harm, or to actually inflict it, in order to get them to move away from the vehicle. In one particularly troubling example, flame thrower devices are disposed beneath a passenger car, which can be activated from within the car to project flame outward from beneath the car to induce persons to move away from the car. It is probably the intent that these extreme devices be used only against carjackers or others intending grave bodily harm to one or more vehicle occupants.

While firearms may be slightly more controllable than flamethrowers in their potential lethality, they typically require users to open a window or other opening, or otherwise expose themselves, in order to use this means of inducement. This can expose a user, in turn, to harm from persons outside the vehicle.

Tear gas, caustic agents, and other obnoxious substances projectable from a vehicle have also been used for this purpose. These can be lethal, for example exploding tear gas canisters have caused death when they go off immediately adjacent a person. In any case there is potential for tragedy when deadly force is used by occupants of a vehicle upon a crowd, demonstrators, etc.

A difficulty is giving warning before use of force, and particularly before use of lethal force in such situations. Unless the vehicle is equipped with a remotely operated bullhorn or the like, persons must typically expose themselves to provide a vocal warning, by loud speech or by use of a bull horn. This can be dangerous. But in some situations a remotely operated bullhorn can be disabled by persons outside the vehicle, by striking it or pulling out the wires that connect it, or cutting them.

### SUMMARY OF THE INVENTION

The inventors have recognized that it would be desirable to provide a less lethal means of inducing persons and animals to move away from a vehicle. In one example an intense sound directed at the area immediately adjacent the vehicle can induce persons to move away. If the sound is unfamiliar, and so loud that it modifies behavior (even just causing a protective action of covering the ears with the hands), it can assist in deterring aggressive behavior and in moving persons away from a vehicle.

Moreover such a device can also be used to give warning in one example. This can be in general whenever a strong warning or loud alert is needed, and specifically before sound at harmful sound pressure level (SPL) is used at close range, as a voice signal can precede a subsequent loud acoustic output.

The invention can include, in one example, high intensity transducers located underneath a vehicle, where they are less accessible to persons adjacent the vehicle, directed at least one of downward to reflect off the ground adjacent the vehicle and outward from under the vehicle. The transducers can project an acoustic output which travels radially outward in all directions to create a zone of exclusion surrounding the vehicle. In one example these can be electroacoustic transducers, in another example they can be modulated air streams generated by chemical, mechanical, generators, and in one example by modulating an exhaust stream from a vehicle engine through a tuned horn. In one example where electroacoustic transducers are used, a multiplicity of transducers disposed in an array on the bottom of the vehicle can be used to provide a directional output in at least one direction out from under the vehicle, give verbal warning, and produce a behavior modifying high intensity acoustic signal output.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 is a schematic side view of an example embodiment of the invention shown in connection with an automobile;

FIG. 2 is a schematic top view of an example embodiment of the invention used in connection with an automobile;

FIG. 3 is a schematic side view of an example embodiment of the invention shown in connection with an armored car (truck);

FIG. 3a is a schematic detail view of the area circumscribed by line A-A in FIG. 3;

FIG. 4 is an exploded, cross-sectional view of a sectioned portion of exemplary transducer arrays which can be attached to the bottom of a vehicle in accordance with principles of the invention;

FIG. 5 is an exploded, cross-sectional view of a sectioned portion of exemplary transducer arrays which can be attached to the bottom of a vehicle in accordance with principles of the invention;

FIG. 6 is an exploded, cross-sectional view of a sectioned portion of an additional transducer array example which can be attached to the bottom of a vehicle in accordance with principles of the invention;

FIG. 7 is a cross-sectional view of a transducer array having a plurality of rows in accordance with FIG. 5 or FIG. 6;

FIG. 8 is a schematic cross-sectional view of a transducer array in accordance with another example of the invention, with a position of louvers shown in an open position, an alternative closed position of the louvers, and in another example, protective covers being the same, shown in outline:

FIG. 9 is a schematic cross-sectional view of a transducer array in another example, with louvers or a cover shown closed over the transducers, and open (in the case of louvers) in outline;

FIG. 10 is a schematic side view illustration of another example embodiment showing some options or features in outline;

FIG. 10A is a schematic diagrammatic view of an alternative construction for a component (reference no. 80) of the system shown in FIG. 10;

FIG. 11 is a schematic top view of the example shown in FIG. 9, illustrating additional optional features in outline;

FIG. 12 is a schematic illustration of a vehicle fuel and ignition powered transducer using a modulated combustion product stream as the means of sound generation, which can be used as a primary sound generation device or an additional sound generation device in the examples illustrated herein (options in features are shown in outline);

FIG. 13 is a schematic cross-sectional illustration partially in break-away of a gas generator useable as a primary sound generation device or as an additional sound generation device in the examples illustrated herein;

FIG. 14 is a side view broken out, partially in break-away of an example embodiment in connection with a railroad train;

FIG. 15 is a top view of the train portion shown in FIG. 14;

FIG. 16 is a schematic side view of an example embodiment in a semi-trailer; and

FIG. 17 is a schematic side view of an example embodiment in a semi-tractor.

Reference will now be made to the exemplary embodiments illustrated, and specific language will be used herein to describe the same. It will nevertheless be understood that no limitation of the scope of the invention is thereby intended.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

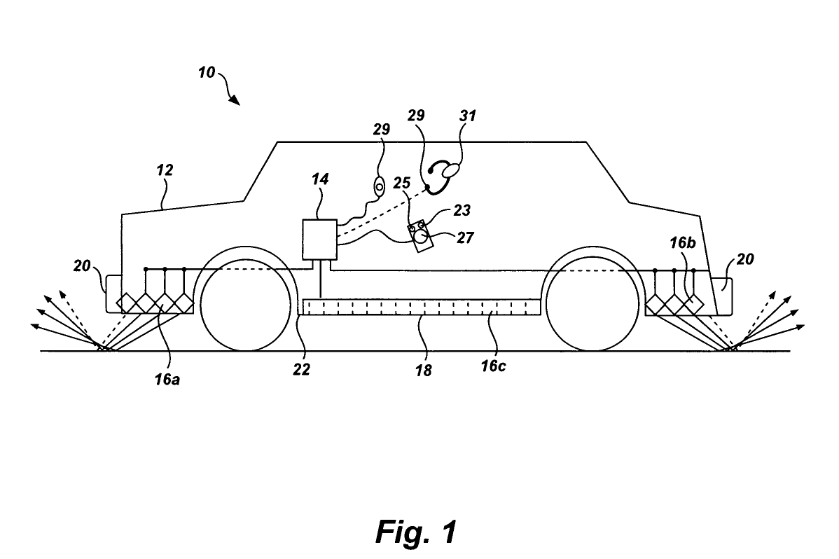

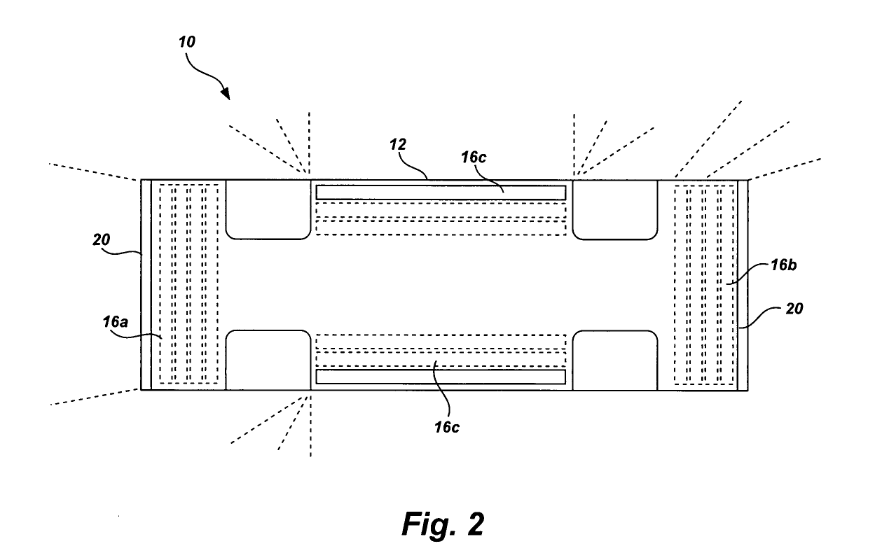

With reference to FIGS. 1 and 2 of the drawings, which are given by way of example, and not by way of limitation, the acoustic system 10 is embodied in a vehicle 12. In this example the vehicle is an automobile, which can have other protective features (not shown). The system includes an audio amplifier and control unit 14, coupled to one or more transducer arrays 16 which can be located in, on or immediately adjacent the front (16a) rear (16b) and sides 16(c) of the vehicle. This allows communication audio signals and deterrent sound combinations to be projected out from under the vehicle in the illustrated example embodiment. Depending upon the embodiment being discussed, the various transducers of the array (or acoustic motors and waveguide(s) that comprise the array), are sometimes referred to herein collectively as the “acoustic emitting system.” It is to be understood that the emitting system can be comprised of a multitude of distinct acoustic transducers, or, in some embodiments, a single (or a relatively few) acoustic motor(s) operably coupled to one or more waveguides.

As shown in FIG. 1, the transducer arrays can be configured to direct an acoustic output downwardly toward the surface on which the vehicle moves, for reflection upwardly toward any humans or animals located on the surface immediately adjacent the vehicle. Furthermore, as illustrated in FIG. 2, the transducer arrays can also project an acoustic output which travels radially outward in all (or most) directions (e.g., in radial sectors having a variety of ranges of angles) to create a zone of exclusion surrounding the vehicle, which can be used to deter persons from closely approaching and/or remaining near the vehicle. In the alternative, the individual transducers 18 can be at least partially directional, and as an array they can be quite directional, and as a result can be controlled by vehicle occupants to direct a beam of sound into any single quadrant surrounding the vehicle, or in portions of one or more adjacent quadrants surrounding the vehicle.

Useful in protecting what is inside the vehicle 12 and in providing room to maneuver, the system 10 provides sound at very high sound pressure levels immediately adjacent the vehicle. The source of the sound would not be apparent to most people, as the transducers 18 and arrays 16 thereof are out of sight. Moreover, defeating the sound at the transducers is more difficult because of their relatively inaccessible location underneath the vehicle, behind bumpers 20, behind rocker panel areas 22, etc. The sound, or acoustic output of the system can be voice, distinct tonal signals arranged in sequence including deterrent sounds or combinations thereof, and combinations of different kinds of different sounds, including the timing of sounds and silences.

The deterrent sounds can be obnoxious, grating, disturbing, etc. This can be done by variance of the frequency, SPL, timing, combining multiple wave forms, tones, etc., to form dissonances, Tartini tones, and combinations in audio signals that are unexpected or unnerving to most humans. In fact at sufficiently high SPL's, almost any sound will be a deterrent, regardless of its nature. In one example, sampling of notorious noises such as fingernails scraping on a chalkboard, or the like is used to form part or all of the deterrent sounds. Variation of sound content and intensity can be a feature of the deterrent sound, so that persons and animals will not become accustomed to the sounds or “acclimatized” to the intensity after some seconds. This decrease in sensitivity to loud noise can happen with human and some animal hearing, as the brain adapts over time, perceived pain decreases, and as the ability to be unnerved and discomfited can lessen.

While the intensity level of the acoustic output can vary, generally speaking the level will be approaching (or exceeding) an intensity level corresponding to an ordinary human pain threshold. While such a level can be somewhat subject, depending upon the subject human, the frequency of the acoustic output, etc., acoustic outputs in accordance with the present invention can fall within ranges including (without limitation): at least about 120 dB; between about 120 and about 130 dB; between about 130 dB and about 140 db; and at least about 140 dB.

The acoustic system 10 can be controlled from within the vehicle 12 via controls which can include a button 23 to arm the system, a voice/deterrent sound selector 25, and send switch 27, which can be combined with a directional toggle, so that a particular direction of projection is selectable, or by pressing in the center, all directions can be essentially subjected to an acoustic signal. A microphone 29 can be hand held or head set 31 mounted for live voice communication from inside to outside the vehicle. The control unit 14 can include storage for deterrent signals or code to generate them, as well as pre-selected and selectable voice communication in one or more languages. In one embodiment a translation device can be included. Such a device is commercially available from VoxTech International of Annapolis Md., marketed under the registered trademark PHRASELATOR. It can generate a pre-recorded voice message in a selected language upon prompt, which can be a voice prompt of speaking a pre-selected word or phrase.

With these controls the system 10 can enable vehicle occupants to give a warning verbally, or to otherwise communicate a message to persons or animals outside the vehicle. It also enables them to provide a deterrent acoustic signal of great intensity just outside the vehicle 12 in a manner they can control, including in one example a direction of projection of such a signal. In one aspect of the invention, an occupant (or a person remote from the vehicle with access to controls of the vehicle) can control a radial sector of projection of the acoustic output. The occupant can adjust the sector of projection from a minimal area (e.g., along only a portion of a single side of the vehicle) to a maximum of about 360 degrees of projection, with a plethora of intervening angles or sectors of projection being possible.

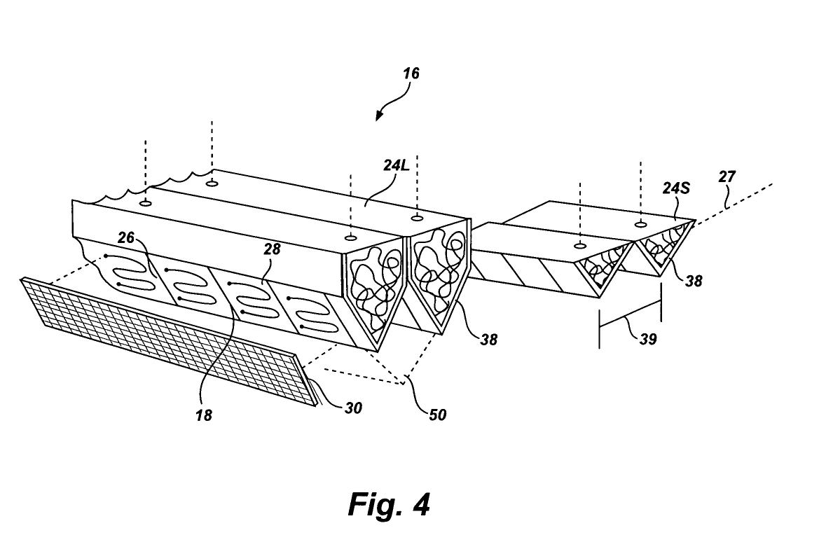

With reference to FIGS. 4, 5, 6, and 7, in the illustrated examples the transducer array 16 includes a multiplicity of transducers 18 carried in an elongated housing 24. The transducers are configured for harsh environmental conditions, and in one embodiment are planar magnetic transducers, as in the example shown in FIG. 4. These transducers have a polymeric resin film diaphragm 26, and thus can be essentially sealed on an outward face 28, to repel moisture. The number of individually actuated transducers for a given length of the elongated array affects the ability to beam steer, and thus the fineness in gradation of control of direction. In one example a single transducer can be used, and the array projects sound along one principle acoustic axis only. A grille covering 30 is positioned in front of the diaphragm, to protect it from stones, strikes from road hazards, plants, and the like which might otherwise damage the diaphragm. The grille in one example is a multi-layered configuration as shown in FIG. 6, including a hydrophobic acoustically transmissive textile 32, sandwiched between two layers of perforated plate 34, 36 or larger opening metal textile in another example. This configuration can provide resistance to deformation and can allow acoustic transmission.

As illustrated by the examples shown in FIG. 4, in one embodiment the elongated housing 24L is larger, to facilitate lower frequency reproduction. Acoustically dissipative material 38 can be used inside the housing to attenuate the backwave from the planar magnetic transducers, particularly at higher frequencies. In another embodiment the elongated housing 24S is smaller, allowing the transducer arrays to consume less space. Below the dotted line 37 the two examples shown are essentially the same. This smaller version limits lower frequency response, but in one example the device can be used in a relatively narrow band of frequencies, for which group of frequencies the housing size is adequate. As will be appreciated, deterrent tones, noise, and other signals can be created within the narrow band. Further, if the resonant frequency of the transducer is within the band used, the resonant frequency range can be used particularly, to increase output SPL.

If more than one array row 16 is used, delay can be used to better coordinate the phase of acoustic signal emitted from the various rows. In another example, a deterrent tone is used which is kept to a narrow fundamental frequency band, and harmonics thereof. This is coordinated with a distance 39 between rows. As a result, the output is

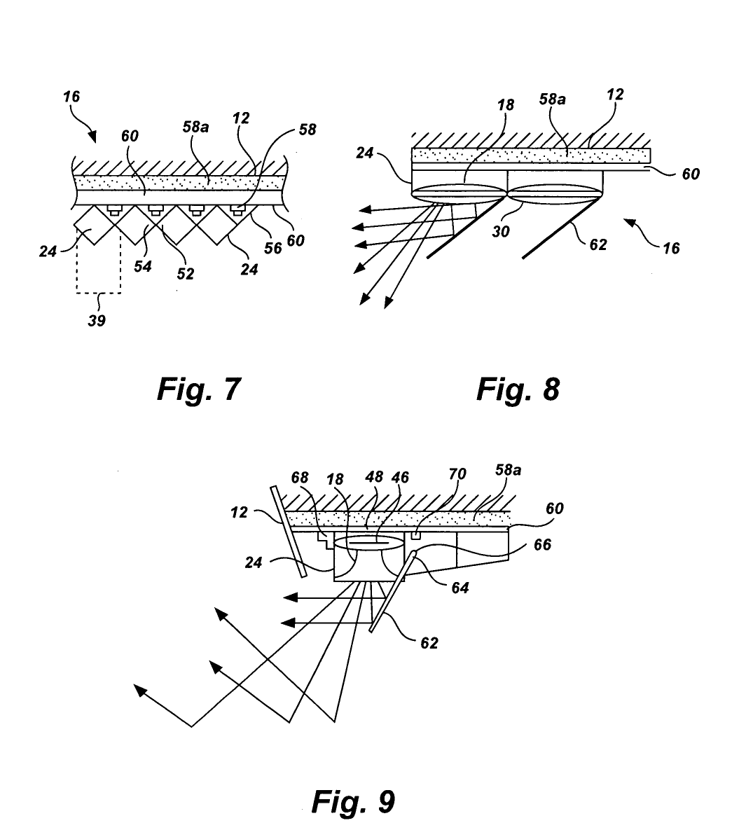

As better seen in FIG. 7, it will also be appreciated that when elongated transducer arrays housings 24 are mounted, a plurality of array rows can be mounted and angled downward and outward, and the front corner 52 of the row behind will just touch the rearward corner 54 of the housing in front of it (producing a saw tooth configuration for the transducer housings). This further protects the inward rows of multiple rows of transducers. The housing of the more outward row(s) protects them to some extent.

Also illustrated in FIG. 7 are angled brackets 56 that can be used to mount the housings 24 of array rows 16 to the bottom of a vehicle 12. Insulating material 58, such as homogeneous, foamed, or layered elastomers, can be located between the transducer housings 24 and the vehicle 12 to dissipate energy, and thus decrease the amount of vibration transferred to the frame of the vehicle. This insulating material also can be in the form of spacers, or additional layers 58a between an outward plate 60 to which the housings 24 are attached, and further structure of the vehicle 12.

With reference to FIG. 8, in another example embodiment the transducers 18 can be made to face downward. In the example shown these are planar magnetic devices, commercially available from the assignee and other manufacturers. In this example movable covers, or louvers 62 can be provided to protect the rows of transducer array housings 24. These can be actuated rotationally as described below. In another embodiment a grille cover 30 as described above can be provided to protect the diaphragm(s). When opened, the louvers can help direct sound downward and more phase aligned than would otherwise be the case, because the sound emitted is reinforced by the other rows, rather than being slightly or significantly phase cancelled by them. Voice signals are intended to be warnings, generally, and one array row, or even a part of one row, is generally sufficient to create a very loud voice communication.

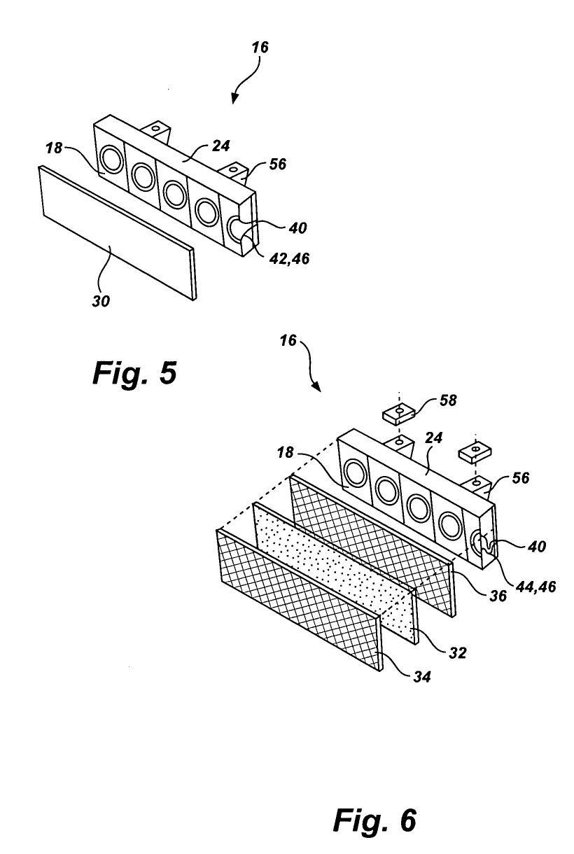

With reference to FIGS. 5 and 6, in another embodiment the transducers 18 are piezo-electric bender (bimorph or monomorph, coin, ceramic, etc.) motors 40 coupled to straight horns 42 (in FIG. 5) or folded horns 44 (in FIG. 6). These transducers can have polymeric resin diaphragms 46 actuated by the piezo-electric elements, and accordingly are inherently water resistant. By angling the transducers downward they are configured to project sound down toward the ground to reflect radially outward from under the car, but also they are thus configured to better drain should water make its way through the horns into a chamber adjacent the diaphragm. Likewise, it will be appreciated that the downward directed transducer of the example shown in FIG. 9 will drain very well. Suitable transducers can be conventional devices which are commercially available from a number of sources.

Such piezoelectric motor 40 devices are typically self contained and have within them any acoustic volume that may be required. Where the transducers require an acoustic volume outside the transducer, such as the acoustic volume 50 provided adjacent the planar magnetic transducers (as shown in FIG. 4), the housing 24 can accommodate this volume. In the example of FIG. 4, the housing is configured so that if a plurality of array 16 rows are used, they can “butt up” against each other. outward, as they slant outward to reflect and direct sound outward from under the vehicle 12.

With reference to FIG. 9, in another example the transducers 18 are of the piezo-electric type, disposed with the horn facing downward. A cover or louver 62 protects the transducers of each row when not in use. A crank 64 and actuator (66 hidden behind the array cover 24 in this view) rotationally actuate the cover. If more than one array row 16 is used, the covers can act as louvers, and again the cover or louvers act as waveguides to direct the sonic output outward from under the vehicle 12. If one row is used, side brackets 68 can be used on both sides of the housing 24. In order to stack housings close together, the side bracket can be replaced by fasteners 70 attaching through the housing directly into the bottom of the vehicle 12, or structure attached to the bottom of the vehicle, such as a mounting plate 60 and insulating (dissipative) material 58a. In another example, modularity can be abandoned in favor of close-packing more transducers onto the bottom of the vehicle, as described below.

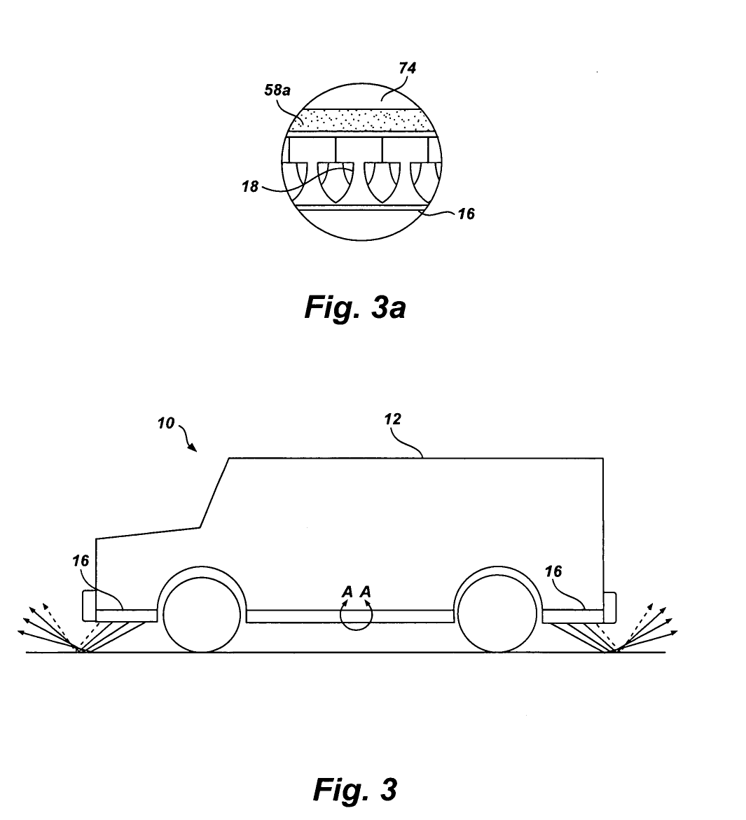

With reference to FIGS. 3 and 3A, in an example shown where the vehicle 12 is an armored car (usually a truck, as shown), the array 16 is large and transducers 18 are close-packed over a wider area. In the illustrated example essentially all the available under-side of the vehicle can have transducers mounted below an armor plate 74, which can be a primary or secondary armor layer. The transducers can be straight horn piezo-bender-motored transducers, with at least the transducers, located in the central portion of the underside of the armored car and directed essentially straight down. Those at the sides can be angled outward, or also directed straight down like those in the more central portion. In this embodiment delays are used to coordinate the phasing of the acoustic signal across the bottom of the vehicle to project the signal out from under the armored car in a single direction, or in a plurality of directions. Essentially the array can be beam steered to the extreme, so that it acts as a gradient to one side or another.

This embodiment allows up to essentially the entire usable bottom surface of the vehicle 12 to be used to mount transducers, and accordingly very large SPL can be generated. In one embodiment foam insulation 58 is used below (or above) the armor plate to reduce sound coupling into the vehicle structure or reduce its effect in the vehicle interior (e.g., to at least partially insulate the interior of the vehicle from the acoustic output). Multiple layers of elastomeric gels, solids or foams or a mix of these, of dissimilar mechanical properties can be used to increase conversion of acoustic energy to heat by increasing internal reflections in the insulating foam. Felts, fiber batting, and other known sound absorbing materials can also be used.

As will be appreciated this system can be used to clear a path for movement of the vehicle 12 through a crowd. It can also be used to deter/hamper thieves or others trying to attack the armored vehicle. It will also provide a loud alarm to alert others in the vicinity that there is trouble. As will be appreciated with all the systems herein described, they can supplement or replace a conventional vehicle horn or siren (not shown) for alerting others. Moreover, they can supplement or replace the transducers for an alarm system of a vehicle. But rather than simply being an annoyance to thieves, they can be a physically effective deterrent due to the very high SPL produced. By the same token, increased protection from false alarms should be provided, as injury to innocent persons is to be avoided. For example, tripping such an alarm would be made difficult or impossible unless the car were actually being moved without authorization, or unauthorized entry is occurring, or an occupant manually triggers the alarm from inside, etc.

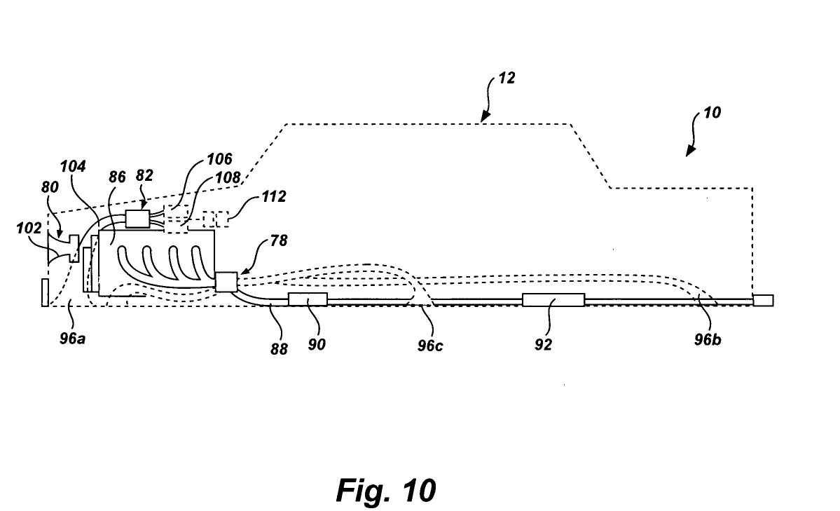

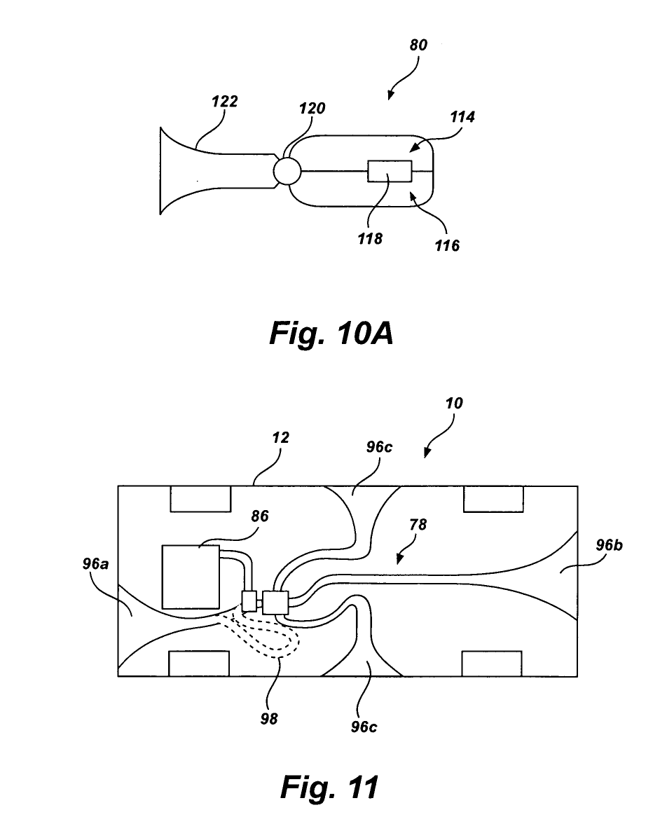

With reference to the example of FIGS. 10 and 11, the system 10 can further include one or more supplementary sonic generators 78, 80, 82. These are modulated air stream devices, and can also be very loud. In supplementary sonic generator 78, the exhaust stream of the engine can be used directly to power such the device. A control valve 84 allows diversion of the exhaust stream from the engine 86 before it continues along the exhaust pipe 88 to the catalytic converter 90 and muffler 92, and before otherwise losing energy in the vehicle exhaust system. This exhaust stream can be further modulated by having it pass through a passive or active means to further accentuate its pressure fluctuation, or the direct stream modulated by the exhaust valve timing of the engine can be used. The diversion can be moved to the exhaust manifold of each individual cylinder of the engine, as further described below.

The modulated exhaust stream can then be further amplified by directing it though a forward horn 96a. In one embodiment the horn is folded to allow more throat length 98. The horn can be essentially two dimensional flaring in the horizontal direction mostly, and mouth opening of the horn is wide and narrow. In one embodiment, shown in outline, it can be essentially flat on top and bottom surfaces, or follow vehicle contours and have little or no flare even at the mouth. In another example it can be a combination of horizontal and vertical dimension flaring in order to fit around vehicle components such as the engine 86 and provide maximum increase in SPL directed forward. In another example rear 96b and side 96c horns can also be provided. A vehicle occupant can direct the exhaust stream through one or more of these additional horns to direct sound in a different direction, or in all four directions at once.

In another example a valve (generally situated behind the exhaust manifold pipes) and diversionary pipe opening into a horn can be provided on each cylinder of the engine 86, to maximize the pressure variation available from the exhaust stream to each horn. In one example each cylinder's horn can be tuned differently, to create a cycling series of frequencies in the deterrent sound output. One or more actuators can be provided to open or close one, several or even all the diversionary valves of the engine, via a translational or rotational arrangement using a linkage.

Another example of a supplementary sonic generator is the engine- or motor-driven modulated sound generator 80, which can be direct driven by the vehicle engine 86, for example via a belt/pulley drive. The output from a coupled horn 102 can be directed forward through a grille portion of the car 12 or can be directed downward to project sound out from under the vehicle as described above. In another example an electric motor (not shown) can be used instead of direct drive from the engine. The electric motor can be in turn powered by the electrical power supply of the vehicle 12. Furthermore, sirens and other devices having an engine-driven air compressor and means to modulate its output can also be used.

With reference to FIG. 10A, another example of a motor-driven supplementary sonic generator 80 includes a pair of pressure vessels 114, 116 which contain pressure and vacuum, respectively. The pressure and vacuum are created by a motor driven pump 118 which moves air from the low pressure (vacuum) vessel to the high pressure vessel to maintain a large differential. A modulator 120 which spins or vibrates connects each of the vessels alternately with the throat of a horn 122, producing a high intensity sound output.

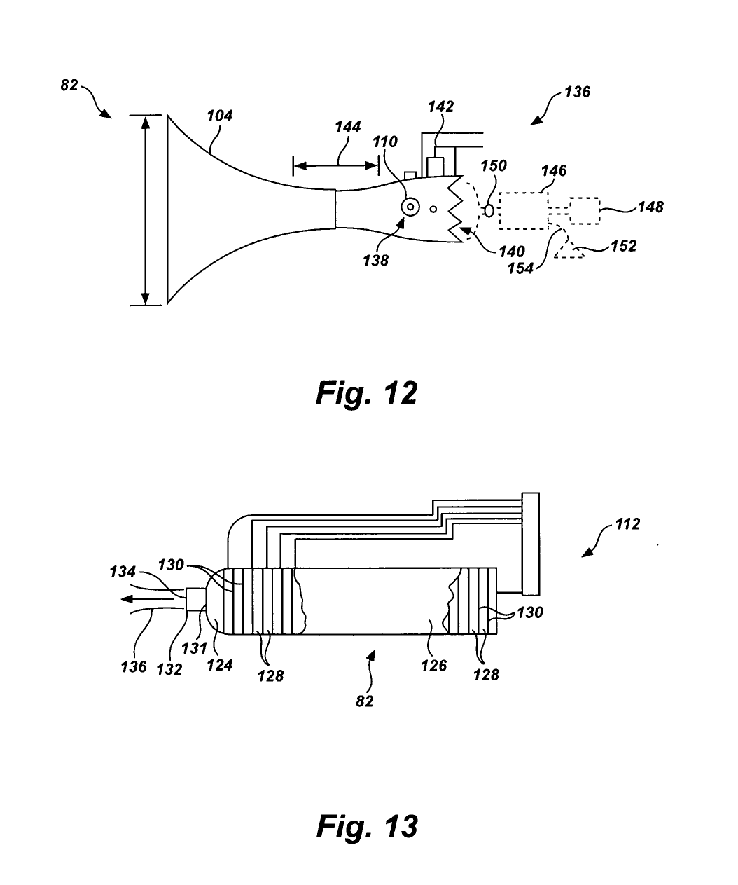

Referring back to FIG. 10, a combustion-driven supplementary sonic generator 82 can also be provided, including a horn portion 104 directed downward so as to project out from below the grille of the vehicle. This supplementary sonic generator can be powered by a source 106 of pressurized fuel in gas form, or liquid form that volatilizes as it is released, such as a propane bottle, or the like, and a source 108 of pressurized air. The combustion-driven supplementary sonic generator 82 can also be powered by a mixture of vehicle fuel, e.g. gasoline, and atmospheric air, as is accomplished in a combustive generator 136 (FIG. 12), where the fuel and air are mixed and intermittently explosively set off by a spark source, such as a spark plug 110 powered by the vehicle ignition system or a separate ignition system powered by the vehicle's electrical power supply.

With continued reference to FIG. 12, the combustive generator 136 creates a modulated gas stream using atmospheric air. It uses gasoline from the vehicle fuel system and spark plug igniters 110 powered by the vehicle's electrical system. In one example, a combustion chamber 138 is coupled to the horn 104 at one end, and to one-way valves, such as reed or flapper valves 140, at the other. These one way valves act as an “air diode,” similar to that of early pulse jet engines. One or more fuel injectors 142, such as automotive fuel injectors, are configured to inject controlled amounts of fuel into the chamber. One or more spark plugs 110 are disposed so as to be able to ignite a fuel air mixture. In one embodiment these can be directly connectable to the vehicle's fuel and ignition system to provide a low frequency sound output variable by varying engine RPM. In another embodiment they are separately controlled, but can obtain power from vehicle systems (conventional, not shown).

As will be appreciated, when the first charge of fuel is ignited in the presence of air in the combustion chamber 138, it will generate a combustion product stream which is directed out into the horn 104 along a throat length 144. The momentum of the exiting gas draws air after it, causing the pressure to drop behind it and a new charge of air to be drawn into the combination chamber through the one-way valves 140. This is mixed with a controlled dose of injected fuel, ignited, and the process repeats. The SPL can be controlled to some extent by the richness/leanness of the fuel air mixture, and the frequency by the timing of the fuel injection and spark. Cooling fins (not shown), a water jacket, or ablative lining, or other means to mitigate high temperatures can be provided to allow longer continuous operation of the combustive generator 136. As mentioned, short bursts may be preferable to long continuous output.

In an example not using atmospheric air, but having increased frequency capability, the one-way valves 140 are replaced by a compressed air stream from a reservoir 146, which in turn can be connected to a compressor 148. A modulator 150 can be provided, or the supply of compressed air can be constant, and modulation provided by the injector(s) 142 and spark plug 110 timing. The spark plug is placed further out toward the horn in the later case, and multiple spark plugs can be used. The compressor and reservoir for this example can of the type commercially available for automotive applications, such as powering air shock systems, air horns, air brakes, etc. The length of bursts depends again on thermal considerations, but also on the capacity of the reservoir 146.

As will be appreciated, as an alternative to combustion one or more conventional air horns 152, or an array of conventional air horns, can be connected via a control valve 154 to such a source of compressed air (146, 148) to produce a sound output without combustion. This allows loud acoustic signals, at least in brief periodic bursts, depending on the capacity of the reservoir and/or the compressor used. Very loud outputs can be achieved with devices using higher pressure. For example, even the small air horns used by divers powered by SCUBA tank pressure to hail or warn watercraft can produce very large SPL's. Provided a vehicle-safe high pressure source can be used with the particular vehicle 12 and application, more pressure generally enables more SPL in the combustion-driven supplementary sonic generator 82 supplementing the transducer arrays 16 described in FIG. 1.

In yet another embodiment of the combustion-driven supplementary sonic generator 82, a source of an air stream can be a chemical gas generator 112 as shown in FIG. 13 and described below, which is passively modulated or controllably actively modulated. This chemical gas generator 112 uses chemical means to generate the air stream in a single use device intended to provide a limited number of bursts of sound and to be replaced after each use. Since the present system is essentially a defensive system, it is hoped this would be infrequent. It can comprise a combustion chamber 124 within a pressure vessel 126. A series of gas generation disks 128, individually electrically fireable by electrical igniters (not shown), are formed of propellant/oxidizer material similar to that of air bag gas generators. They each are configured to have a burn rate selected to produce the desired pressure in the pressure vessel for a desired length of time. They can be separated by frangible insulating layers 130.

The chemical gas generator 112 allows a series of bursts of sound, each lasting up to several seconds, to be created. Since human hearing tends to desensitize over time exposure, short duration high intensity bursts of sound can be most effective in deterrence. An individual firing line to each disk is provided so they can be sequentially set off in a controlled manner. A screen 131 is provided to break up any unacceptably large piece of the frangible insulating material, which is selected to be inflammable, but ablative, and to break up into small pieces so that it can pass through a passive modulator 132 without interfering with its function. The passive modulator can be a vibrating disk or diaphragm 134, or other conventional means, to produce a tone or series of tones, all of which pass on into the throat 136 of the horn (104 in FIG. 10) coupled to the generator.

All these secondary, or supplementary sonic generators 78, 80, 82 are controlled by the system controller (14 in FIG. 1) described above. The electrical transducer arrays 16 in FIG. 1 allow for very intelligible voice communication prior to or interleaved with deterrent sounds producible by means of the arrays alone or as supplemented by such other modalities as just described. Moreover, having one or more supplementary generators provides redundancy, which is advantageous.

In one exemplary embodiment (not shown), the acoustic motor can include a compression driver and the waveguide can include a 360-degree waveguide that directs acoustic output from the motor radially outward in substantially all directions from an effective center of the vehicle. It is contemplated that such a configuration could be “focused” (e.g., the radial output could be limited to a particular radial sector) in a variety of manners appreciable by one of ordinary skill in the art having possession of the present disclosure.

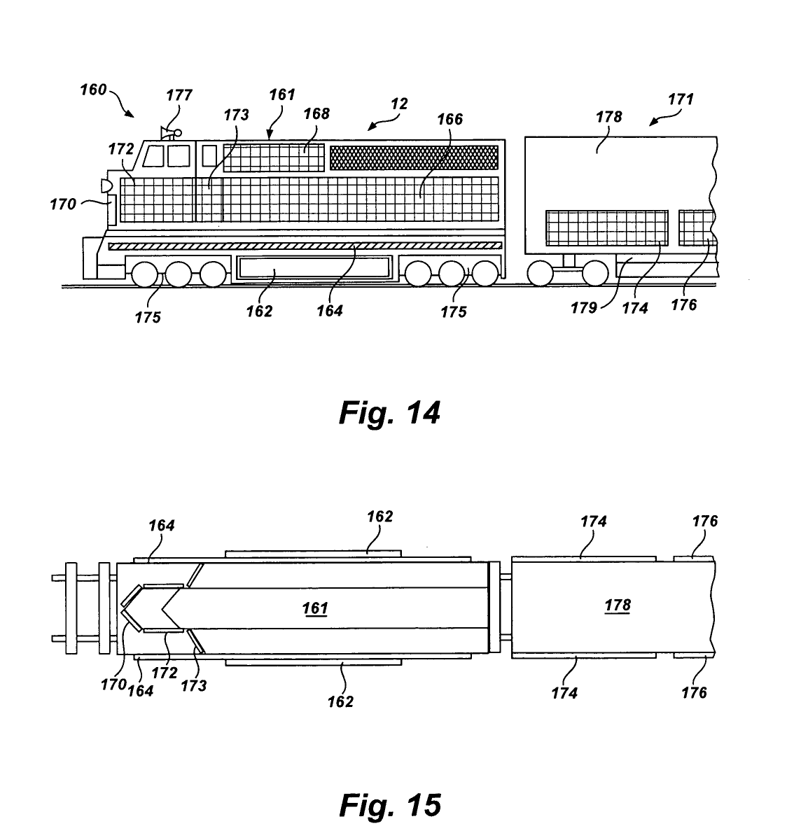

With reference to FIGS. 14 and 15, in another embodiment 160 the system is disposed on a locomotive 161 and/or elsewhere on a train vehicle. Trains carrying controversial materials are the subject of demonstrations by protestors, whose activities might include sitting or lying on the tracks in one or more places where the train is forced by other circumstances to reduce speed to so low a speed that it can stop for them. Often such trains cannot come to a complete stop by military order. Protestors have been severely injured in such demonstrations. The invention can be used as a first step in a measured escalating response to this situation, providing authoritative communication and a deterrent acoustic signal capability. Combined with other measures, very intense bursts of sound can be effective in modifying behavior.

The large sill-face areas and large available power make very large SPL's practicable. Arrays 162, 164, 166, 168, 172 along the sides of the locomotive can be used as gradient arrays phased to project sound forward. They can also be used to keep sides of the locomotive and track clear. Using delay, the output can be beam steered to desired directions on the sides of the tracks. Transducer arrays 175 can be placed on bottom surfaces of the structure so as to not interfere with locomotive operations. Forward facing arrays 170, 173, can project sound forward. These arrays can generate high intensity sound and can be used for both voice and behavior-modifying audio outputs to clear the track of persons or animals immediately in front and to the sides of the locomotive. In another example the arrays can be supplemented by air horns, such as the air horns 177 used by the train operator for alerting and warning. These can be placed in protected locations beneath, in front of, and to the sides of the locomotive. Closer proximity and a multiplicity of such horns can provide additional or alternative means to produce large SPL in the area immediately adjacent the locomotive. Since provisions for such horns are typical on a locomotive, adding more provisions for more such horns which are instead placed down low on the locomotive is made relatively easier.

One or more arrays 16 (as described above) can also be provided to aid in issuing loud verbal warnings before applying intense sound signals to the area. This can be used to protect the train 160 and/or specialized cars 178, for example those hauling things or persons which are valuable, important, dangerous, controversial, etc. Protestors who sit on the tracks in front of approaching trains carrying nuclear materials, for example, can be motivated to clear away. Even using ear protection, sound pressure levels near the train can be made so high that it would be unpleasant and/or very painful to remain in the area immediately adjacent the train.

In another embodiment 171 one or more arrays are disposed on the bottom 179 and sides 174, 176 of one or more rail cars 178. The system can be applied to many cars in a train. When used in a coordinated way, output from a plurality of cars can provide additional output forward when used in a gradient way, but also enables beam steering to locations to the sides of the train. In any event, a very loud signal will be present in the area immediately adjacent the arrays, creating an exclusion zone in front of and to the side of the cars individually or collectively.

In another aspect of the present invention a specialized rail car 178 embodying the system can be pushed ahead of a locomotive 160 when trouble is anticipated. In such a situation the specialized rail car can include other systems intended to motivate persons or animals—persons particularly—to leave the area immediately ahead of the train. For example, jets of air or water, tear gas, pepper spray, or other means can be combined with the system to provide a measured and appropriate response, and a progression of severity of measures for inducing people to leave the area immediately ahead of the train.

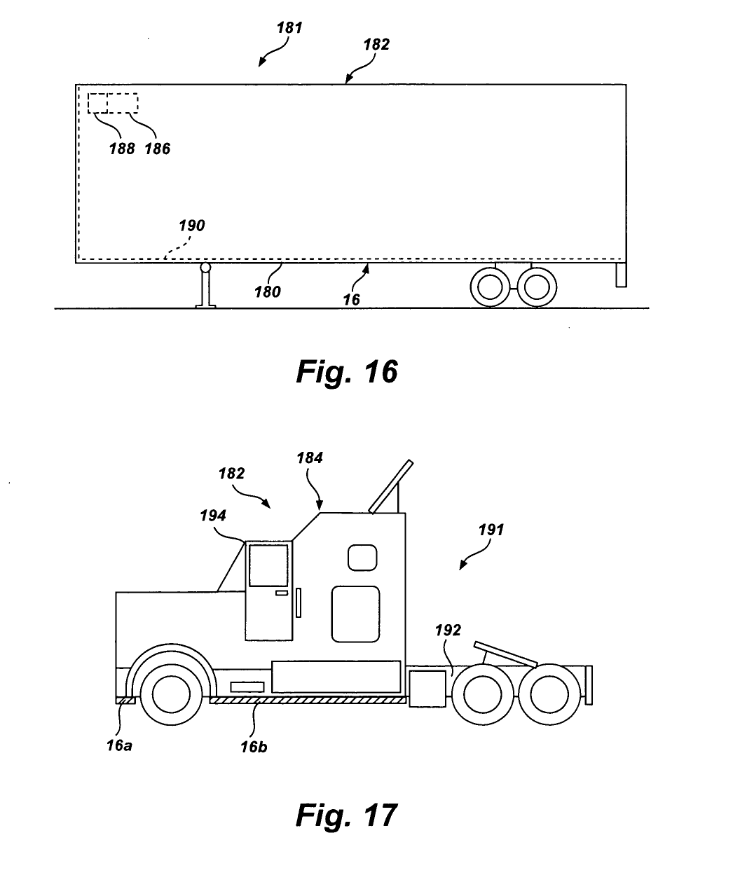

With reference to FIGS. 16 and 17, in another embodiment 181 a bottom surface 180 of a semi trailer 182 can include an array 16. In one example, a large portion, or all of the available surface area can be covered with transducers. Up to a very large number of transducers can be used. This can be used to protect and provide maneuvering room for a semi-trailer 182 and tractor 184 combination. When such a vehicle 12 is carrying a controversial or valuable load, it may need to overcome blockade by protestors, or strikers, or by thieves, or by other persons intent on doing harm. As will be appreciated, a semi tractor 184 can be likewise provided with transducer arrays 16a, 16c, for these purposes herein discussed.

In one embodiment the semi trailer has its own battery 186 and sound signal generator/controller amplifier 188, which can power the system independently when the trailer is unhitched. The battery and controller/amplifier for the system is located in a secure location inside or attached to the trailer. Wires 190 to the array are hidden and secure, all this to make the system more difficult to interfere with. The system can be connected to sensors (not shown), to become an alarm, in one embodiment, as well as a deterrent, which activates if the trailer is unduly tampered with.

In another example 191 shown in FIG. 17, the semi tractor 184 can include the acoustic system 10 described in FIG. 1 as well. Transducer arrays 16 can be placed behind the front bumper, and underneath the tractor. Moreover, they can be placed along the frame rails 192, and other available locations which are protected and wherein the array transducers will not interfere with normal operation of the vehicle. Supplementary systems, as discussed above, can also be used. With the ability to induce persons to move to clear a path in front of it, to the side, etc., to provide maneuvering room, the semi tractor 184 can be used to move valuable, controversial, important, etc. cargo through an uncooperative crowd, demonstration, picket line, etc. This can be done without the operator having to leave the cab 194.

In a manner similar to those examples and embodiments given and discussed hereinabove in connection with all the drawing figures provided herein, the acoustic system 10 can be applied to other large vehicles involved in sometimes controversial situations, such as construction equipment. It can be used as before described to clear persons from the immediate vicinity to provide maneuvering room in a potentially dangerous situation such as moving though a crowd in a demonstration, strike or other labor troubles, etc. The system as described above can also serve as an alarm/unauthorized use deterrent, as such equipment is often unattended at night and at other times.

Furthermore, it will be appreciated that the acoustic system 10 can be used on many types of vehicles including boats, and other surface vehicles of all types including aircraft while they are on the ground, buses, motor homes, vans, firefighting vehicles, police vehicles, military vehicles, etc. Again, such vehicles that may be anticipated to carry something controversial, important or valuable where the risks of injury described above are present can use the system 10 provided the transducer arrays 16 can be protected. In general, particularly those vehicles having an enclosure for persons to get inside to be protected from the effects of the intense acoustic signal the system can create just outside the vehicle can be beneficially fitted with the system.

Again with reference to all the drawing figures, in all these embodiment examples it will be appreciated that persons inside the vehicle can be protected from the effects of the acoustic system 10. Vehicles of many types, having cabs, cabins, etc., the interior of which can be made lower in noise level than the exterior, are particularly suited to implementation of the invention as discussed above. As a particularly good example, modern automobiles are usually equipped with sound reducing features to insulate the occupants from outside noise, and most automobile interiors are very much quieter than the area immediately adjacent but outside the passenger compartment.

The sound insulating provided by most automobile manufacturers allows the interior to be tolerable, even when very high sound pressure levels are created by the system 10 in the area just outside. This can be quite effective in protecting persons inside the vehicle. Additional sound absorbing, reflecting, and insulating materials and measures can be used (e.g. 58, 58a). Isolation of the transducers 18 and other supplementary sonic generators (e.g. 78, 80, 82) from the vehicle frame, provision of additional layers of foam, fiber batting, etc., and other passive measures, such as automatically closing all windows of the vehicle before activating it, and the like, can be used. Also, active noise cancellation within the vehicle can be used, by providing noise canceling headphones, or by providing null zones in locations where occupant's heads will be located ordinarily. Conventional and known noise cancellation techniques and equipment are usable to accomplish this, and are widely commercially available. Lastly, the vehicle can carry ear protection in the form of headgear and/or earplugs.

As discussed, in most embodiments of the invention, the acoustic emitting system can include one or more acoustic motors operable to radiate sound into one or more waveguides (or one or more integral acoustic transducers). Generally, the motors and waveguides (or integral transducer units) will be mounted to an underside of the vehicle. In many cases, the system will be coupled to existing structure beneath the vehicle, and so may detract from the ground clearance of the vehicle, potentially creating issues as the vehicle negotiates undulating terrain, curbs, bumps, etc. To mitigate this problem, the acoustic emitting system can include a minimal height profile. In one aspect of the invention, the height profile of the system can be on the order of from about 0.5 inches to about 1 inch. In another aspect, the profile is less than about 2.5 inches. In yet another example, the height profile can be on the order of about 1 inch to about 4 inches.

In addition, it is contemplated that the present is well suited for use on armored vehicles. Many such vehicles include armored plating applied to an underside of the vehicle in an area roughly corresponding to (but perhaps slightly larger than) the interior of the vehicle occupied by drivers and/or passengers. As such, there may be little available space in these types of applications for the installation of the acoustic emitting system beneath the cabin of the vehicle (or it may be difficult, or prohibited, to attach structure to the armored plating). To accommodate this type of vehicle, in one embodiment of the invention the acoustic transmitters (or motors/waveguides) can be primarily installed in frontal and rearward sections of the vehicle, forward of the front axle and rearward of the rear axle, respectively. The various transducers can nonetheless be oriented to provide the acoustic output radially outward in a substantially 360 degree maximum sector of transmission (that can be narrowed, as desired: as described in accordance with the embodiments above).

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Accordingly, the scope of the invention should be determined solely by the appended claims and their legal equivalents, rather than by the descriptions and examples given above.

What is claimed and desired to be secured by Letters Patent is:

1. An acoustic behavior modification system operable to create a zone of exclusion immediately adjacent a vehicle, comprising:
an acoustic emitting system including at least one acoustic motor operable to generate sound into at least one waveguide, the at least one motor and waveguide each being attached to the vehicle in a location on the vehicle not readily accessible by humans adjacent the vehicle;
the acoustic emitting system being operable to project acoustic output radially outward from at least two sides of the vehicle at sound pressure levels at or above a human pain threshold to motivate humans within the zone of exclusion to modify their behavior.

2. The behavior modification system of claim 1, wherein the acoustic output is directed firstly at a downward angle toward a surface on which the vehicle moves, for reflection secondly at a upward angle toward the humans adjacent the vehicle.

3. The behavior modification system of claim 1, wherein the at least one motor and waveguide are attached to an undersurface of the vehicle.

4. The behavior modification system of claim 1, wherein the acoustic output includes a voice communication and a high intensity sound signal.

5. The behavior modification system of claim 1, wherein the acoustic output includes a plurality of distinct tonal signals arranged in sequence.

6. The behavior modification system of claim 1, wherein an interior space of the vehicle is insulated from exposure to the acoustic output, said interior space being arranged to contain human occupants.

7. The behavior modification system of claim 1, wherein a radially outward sector of projection of the acoustic output can be focused to within a sector that is more narrow than a maximum angled radial sector in which the system is capable of directing sound.

8. The behavior modification system of claim 7, wherein an occupant of the vehicle can narrow the radial sector of projection.

9. The behavior modification system of claim 1, wherein combustive gas is utilized to generate the acoustic output.

10. The behavior modification system of claim 1, wherein a modulated air stream is utilized to generate the acoustic output.

11. An acoustic behavior modification system for use in association with a vehicle, comprising:
an array of acoustic transducers attached to the vehicle, the array being disposed in a location on the vehicle not readily accessible by humans adjacent the vehicle;
the array being configured to direct an acoustic output downwardly toward a surface on which the vehicle moves, for reflection upwardly toward at least one human or animal located on the surface adjacent the vehicle.

12. The behavior modification system of claim 11, wherein the acoustic output is projected at sound pressure levels at or above a human pain threshold.

13. The behavior modification system of claim 11, wherein the array is configured to project the acoustic output radially outward from the vehicle in a substantially 360 degree sector of projection.

14. The behavior modification system of claim 11, wherein the array of acoustic transducers is attached to an undersurface of the vehicle.

15. The behavior modification system of claim 11, wherein the acoustic output includes a voice communication and a high intensity sound signal.

16. The behavior modification system of claim 11, wherein the acoustic output includes a plurality of distinct tonal signals arranged in sequence.

17. The behavior modification system of claim 11, wherein an interior space of the vehicle is insulated from exposure to the acoustic output, said interior space being arranged to contain human occupants.

18. The behavior modification system of claim 11, wherein combustive gas is utilized to generate the acoustic output.

19. An acoustic human and animal behavior modification system for creating a zone of exclusion immediately adjacent a vehicle, comprising:
an array of acoustic transducers attached to a vehicle, the array being disposed on an undersurface of the vehicle in a location not readily accessible by humans adjacent the vehicle;
the array being operable to project acoustic output radially outward from the vehicle at sound pressure levels at or above a human pain threshold to motivate humans within the zone of exclusion to modify their behavior;
the array being configured to direct an acoustic output downwardly toward a surface on which the vehicle moves, for reflection upwardly toward at least one human or animal located on the surface adjacent the vehicle.

20. The behavior modification system of claim 19, wherein the acoustic output includes a voice communication and a high intensity sound signal.

21. The behavior modification system of claim 19, wherein the acoustic output includes a plurality of distinct tonal signals arranged in sequence.

22. The behavior modification system of claim 19, wherein an interior space of the vehicle is insulated from exposure to the acoustic output, said interior space being arranged to contain human occupants.

23. The behavior modification system of claim 19, wherein the array is configured to project the acoustic output radially outward from the vehicle in a substantially 360 degree radial sector.

24. The behavior modification system of claim 19, wherein a radially outward sector of projection of the acoustic output can be focused to within a sector that is more narrow than a maximum radial sector in which the system is capable of directing sound.

25. The behavior modification system of claim 24, wherein an occupant of the vehicle can narrow the radial sector of projection.
